(19) United States
(12) Patent Application Publication
(10) Pub. No.: US 2015/0186635 A1
(43) Pub. Date: Jul. 2, 2015

(54) Granular Redaction of Resources

(71) Applicants: Madjid F. Nakhjiri, San Diego, CA (US); James M. Hunter, San Jose, CA (US)

(72) Inventors: Madjid F. Nakhjiri, San Diego, CA (US); James M. Hunter, San Jose, CA (US)

(21) Appl. No.: 14/146,099

(22) Filed: Jan. 2, 2014

(51) Int. Cl. G06F 21/34; G06F 21/62

(52) U.S. Cl. CPC G06F 21/34; G06F 21/6218; G06F 2221/2113

(57) ABSTRACT

A method for providing redacted representations of data. The method comprises hosting a resource on a server that comprises data pieces each tagged with a redaction level, generating a plurality of redacted representations of the resource, each redacted representations being designated for one of a plurality of authorization levels that each corresponding to a different range of redaction levels, and the redacted representation for a particular authorization level containing one or more of the data pieces that are tagged with a redaction level that falls within the range of redaction levels for that particular authorization level, receiving a request from a client comprising a claimed authorization level, and providing the client with one of the redacted representations that is designated for the authorization level that matches the claimed authorization level.

### CLAIM OF PRIORITY

This application claims priority under 35 U.S.C. §119(e) from earlier filed U.S. Provisional Application Ser. No. 61/748,445, filed Jan. 2, 2013, and earlier filed U.S. Provisional Application Ser. No. 61/757,388, filed Jan. 28, 2013, both of which are hereby incorporated by reference.

### TECHNICAL FIELD

The present disclosure relates to the field of data redaction, particularly a method of redacting data resources based on a requesting client's authorization level and the redaction levels of data within a requested resource.

### BACKGROUND

In many networked systems, such as those that have a Representational State Transfer (REST) architectural style, client devices can send requests to servers for data stored as abstract resources on the servers. The servers can respond to the requests for resources by returning a representation of the resource to the client instead of the actual resource. For example, a healthcare sensor can upload its measurements to a resource on a server, and client devices can obtain a representation from the server that includes the sensor's measurements instead of communicating with the sensor itself.

In many situations some or all data within a resource can be sensitive, private, and/or be subject to secrecy requirements. For example, healthcare records can contain different types of information, some of which can be more sensitive than others. When responding to a client's request for a resource, it can be desirable to limit the client's access to only the portion of the resource that the client is authorized to access. For example, a doctor can be allowed to view a patient's full medical record, while a family member can be granted permission to view general diagnoses but not full test results. As another example, some clients can have authority to access representations of resources that contain measurements from one sensor but not another sensor.

Some previous systems have been developed that allow clients to access representations of resources depending on what they are authorized to view or edit. For example, the ETSI Machine to Machine (M2M) standardization committee has developed a resource-based architecture with a service layer, which can represent sensors as resources that can be reached through uniform resource identifiers (URIs) using service layer primitives. However, the ETSI M2M system only allows a resource to be flagged as viewable or editable globally for the entire resource through RETRIEVE and UPDATE primitives that are similar to HTTP GET and POST methods, and only provides a permission flag for READ, WRITE, DELETE, or CREATE in an accessRights attribute for each resource. This functionality does not allow data of different sensitivity levels within the same resource, or the client's authorization level, to be taken into account to grant a client access to a portion of the resource if the client is not authorized to access to the full resource.

It can also be desirable to allow clients to subscribe to updates or notifications regarding specific resources. By way of a non-limiting example, a doctor can desire to subscribe his client device to receive updates regarding a resource that contains data from a particular health monitor, such that the doctor's client device is notified when the measurements in the resource change. Again, the data from the sensor can be sensitive, and it can be desirable to limit which clients can subscribe to updates or notifications regarding data of certain sensitivity levels, or to provide updates to subscribed clients based on whether the client is authorized to access the portion of the resource that has been updated.

The ETSI M2M system's service layer allows for a notification system in which clients can subscribe to receive updates about particular devices. When the resource for the device is updated, the system can send the subscribed clients a notification of the update, and point them to a server to obtain the updated information. However, these subscriptions can only be set to on or off for each client in the ETSI M2M system, and the sensitivity level of the data and each client's authorization level are not considered when determining which clients to notify about updates or what portions of updated resources should be provided to subscribing clients that receive notifications.

### SUMMARY

What is needed is a system that allows for resources that contain data of varying sensitivity levels, and that can present redacted representations of resources and/or notifications of updates to clients based on the user's authorization level.

In one embodiment, the present disclosure provides a method for providing redacted representations of data, the method comprising hosting a resource on a server, the resource comprising a plurality of data pieces each tagged with one of a plurality of redaction levels, generating a plurality of redacted representations of the resource at the server, wherein each of the plurality of redacted representations is designated for one of a plurality of authorization levels each corresponding to a different range of redaction levels, and the redacted representation for a particular one of the plurality of authorization levels containing one or more of the plurality of data pieces that are tagged with one of a plurality of redaction levels that falls within the range of redaction levels for that particular one of the plurality of authorization levels, receiving a request from a client, the request comprising a claimed authorization level, and providing the client with one of the plurality of redacted representations that is designated for the one of the plurality of authorization levels that matches the claimed authorization level.

In another embodiment, the present disclosure provides a method for providing redacted representations of data, the method comprising receiving encrypted measurements from a sensor at a service layer of a server, decrypting the measurements at an application layer at the server, updating a resource stored within the application layer at the server with the measurements, wherein the resource and the measurements each comprise one or more data pieces tagged with one of a plurality of redaction levels, generating a redacted representation of the resource within the application layer at the server for a particular authorization level, the particular authorization level being mapped to a maximum redaction level, by including in the redacted representation each data piece of the resource that is tagged with a redaction level less than or equal to the maximum redaction level for the particular authorization level, notifying through the service layer one or more subscribing clients that have been assigned the particular authorization level that the redacted representation is available, and providing the redacted representation to any of the one or more subscribing clients that submit a request to access the redacted representation.

### BRIEF DESCRIPTION OF THE DRAWINGS

Further details of the present invention are explained with the help of the attached drawings in which:

FIG. 1 depicts an exemplary system in which clients and sensors are in communication with servers.

FIG. 2 depicts the interaction between clients and servers in a RESTful system.

FIG. 3 depicts exemplary embodiments of requests sent from clients to servers in a RESTful system.

FIG. 4A depicts a first exemplary embodiment of mapping between redaction levels and authorization levels.

FIG. 4B depicts a second exemplary embodiment of mapping between redaction levels and authorization levels.

FIG. 5 depicts examples of redacted representations generated from a resource.

FIG. 6 depicts an exemplary system illustrating interactions between clients, servers, and sensors.

FIG. 7 depicts the application layers and service layers of sensors, servers, and clients.

FIG. 8 depicts an exemplary information cycle following data from sensors through servers to clients.

FIG. 9 depicts an example of data encrypted and decrypted data passing from a sensor to a server to one or more clients.

FIG. 10 depicts a first exemplary authorization process.

FIG. 11 depicts a second exemplary authorization process.

FIG. 12 depicts a third exemplary authorization process.

FIG. 13 depicts a first exemplary scenario for providing clients with redacted representations.

FIG. 14 depicts a second exemplary scenario for providing clients with redacted representations.

FIG. 15 depicts a third exemplary scenario for providing clients with redacted representations.

FIG. 16 depicts a fourth exemplary scenario for providing clients with redacted representations.

FIG. 17A depicts a first exemplary embodiment of mapping between urgency levels and responsiveness levels.

FIG. 17B depicts a second exemplary embodiment of mapping between urgency levels and responsiveness levels.

FIG. 18 depicts an exemplary computer system.

### DETAILED DESCRIPTION

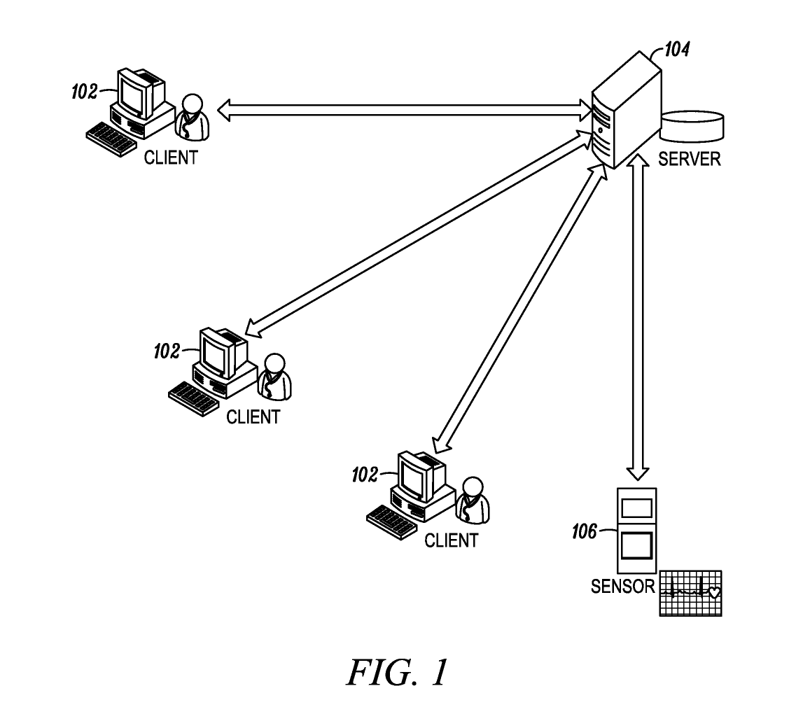

FIG. 1 depicts an example of a system in which clients 102 are in communication with servers 104. In some embodiments, a client 102 can be in data communication with one or more servers 104 over a network, such as the internet or a local intranet. Clients 102 can be devices such as computers, tablet computers, mobile phones, personal digital assistants, or any other device that can be configured to communicate with a server 104 through a web browser or other data connection. Servers 104 can be computers or other devices that electronically store information and can transmit some or all of that information to clients 102. In some embodiments, clients 102 can be communication with any particular server 104 through one or more proxy servers.

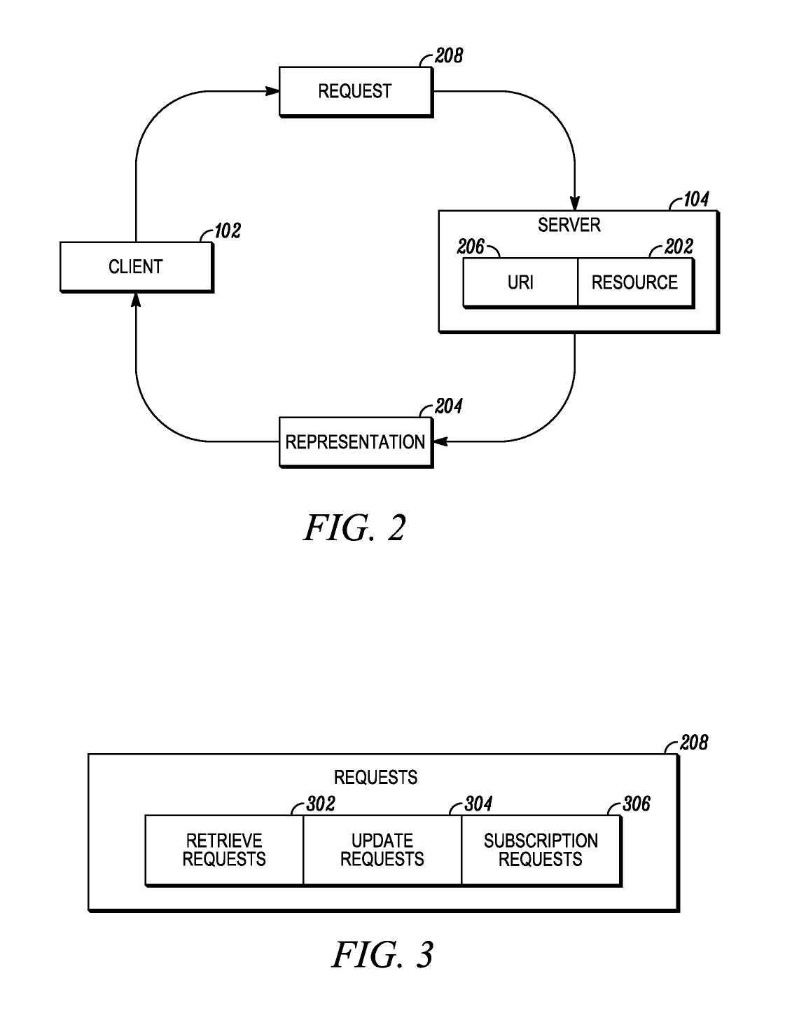

In some embodiments, clients 102 and servers 104 can be in communication in a system having a Representational State Transfer (REST) architectural style. In other embodiments, clients 102 and servers 104 can be in communication through other system architectures or protocols such as SOAP (Simple Object Access Protocol), CORBA (Common Object Request Broker Architecture), RPC (Remote Procedure Call), or any other architecture or protocol. As shown in FIG. 2, systems that use the REST style (RESTful systems) or other similar styles can use the concepts of resources 202 and representations 204. A resource 202 can be an object, file, or any other type of data stored on a server 104. A resource 202 can be identified through a uniform resource identifier (URI) 206 that indicates the location of the resource 202. A URI 206 can be a uniform resource locator (URL), a uniform resource name (URN), a combination of a URL and a URN, or any other type of location identifier.

In a RESTful system or other similar system, a client 102 can send a request 208 to a server 104, and the server 104 can respond to the request 208 by returning a representation 204 of the resource 202 to the client 102, instead of sending the actual resource 202 or allowing the resource 202 to be directly loaded or edited by the client 102. The representation 204 can be a copy of the resource 202, a copy of a portion of a resource 202, a copy of some or all of the resource 202 in a different format, or any other version of the resource 202. By way of a non-limiting example, a server 104 can send a copy of a particular database field to a client 102 as a representation 204 in response to a request 208, while maintaining the full database as a resource 202 on the server 104.

FIG. 3 depicts a chart of exemplary types of requests 208 for resources 202. Clients 102 can send requests 208 for resources 202 to clients 102, such as retrieve requests 302, update requests 304, and/or subscription requests 306. A retrieve request 302 can be a request to retrieve a representation 204 of a resource 202, which can be sent by a client 102 to a server 104 to obtain data about a resource 202 from the server 104. By way of a non-limiting example, a client 102 operated by a nurse in a healthcare environment can send a retrieve request 302 to a server 104 to obtain the latest blood pressure data about a patient from the server 104. An update request 304 can be a request to update a resource 202, which can be sent by a client 102 to a server 104 to write new data into a resource 202 on the server 104, and/or update previous data stored in the resource 202 on the server 104. A subscription request 306 can be a request for a subscription for updates regarding a resource 202, which can be sent by a client 102 to a server 104 to subscribe to updates or notifications regarding a resource 202 on the server 104.

In some embodiments, requests 208 can be similar to requests in the Hypertext Transfer Protocol (HTTP), in which the primitives and/or methods involve a request from a client 102 and a response from a server 104. By way of non-limiting examples, a retrieve request 302 can be similar to an HTTP GET request, and an update request 304 can be similar to an HTTP PUT request. In other embodiments, requests 208 can have any other format, such as being similar to messages in the Constrained Application Protocol (CoAP), messages in local APIs between clients 102 and servers 104 located on the same machine, or any other messaging mechanism.

Returning to FIG. 1, one or more sensors 106 can also be in communication with one or more servers 104. Sensors 106 can be monitoring or measurement devices that can monitor information or take measurements, such as medical sensors, military sensors, security sensors, weather sensors, or any other type of sensor. By way of non-limiting examples, blood pressure monitors, heartbeat monitors, and other health monitoring equipment are sensors 106 that are commonly used in hospitals and medical environments to monitor patients' vital signs.

The sensors 106 can be in data communication with other devices, such as one or more servers 104, such that the sensors 106 can transmit their measurements or other output to other devices. In some embodiments a sensor 106 can act as a type of client 102, such that it can transmit its output to a server 104 using an update request 304 or other type of message to create or update data in a resource 202 on the server 104. In some embodiments, a resource 202 on a server 104 can be devoted to data from a single sensor 106. In other embodiments, a single resource 202 can contain data from multiple sensors 106, and/or contain data from multiple sources such as a combination of data uploaded from sensors 106 and clients 102.

In some embodiments a RESTful system or other similar system can allow clients 102 to access data uploaded from sensors 106 without direct interaction between the clients 102 and the sensors 106 by instead interacting with a server 104. A sensor 106 can upload its measurements to a server 104 to update a resource 202 on the server 104 with the most recent data. A client 102 can request a representation 204 of that resource 202 from the server 104 to obtain the most recent data rather than obtaining the data from the sensor 106 directly. By way of a non-limiting example, a blood pressure monitor can upload measurements to a resource 202 on a server 104, thereby allowing a doctor's computer to obtain a patient's recent blood pressure measurements by requesting a representation 204 from the resource 202 on the server 104 instead of communicating directly with the blood pressure monitor. This can allow a client 102 to obtain the most recent data regardless of whether a sensor 106 is itself active or online. Additionally, network bandwidth and/or the sensor's battery life can be preserved because the sensor can be “sleepy” and only report its measurements or updates to a server 104 when it is awake and connected rather than requiring a constant active connection.

In many cases, some or all data within a resource 202 can be sensitive, private, critical, and/or be subject to secrecy requirements. Data of different sensitivity levels can sometimes be included within a single resource 202, such as data that is considered unrestricted, low sensitivity, normal sensitivity, or high sensitivity. By way of a non-limiting example, a hospital patient's healthcare record can contain both highly sensitive measurements uploaded from a sensor 106 and less sensitive data typed by a clerk during the patient's admission to the hospital.

In addition, different clients 102 or users of clients 102 can have different levels of authority. By way of a non-limiting example, a doctor in a hospital can have more authority than a nurse. In some situations, clients 102 having higher authorization levels can be granted access to data that is more sensitive than clients 102 with lower authorization levels. In these cases, access to data within a resource 202 that is tagged with a particular sensitivity level can be granted to only those clients 102 that have been authorized to view, edit, or subscribe to the data of that sensitivity level. Because various data within a single resource 202 can have different sensitivity levels, clients 102 of different authorization levels can have authority to view different portions of the same resource 202. By way of a non-limiting example, a doctor can be given authority to access the full details of a patient's medical record within a resource 202, while a patient's family members or an insurance provider can be given a lower authorization level such that they can only access basic information about the patient within that same resource 202.

Redaction can be used to allow clients 102 to retrieve, update, and/or subscribe to those portions of resources 202 that they are authorized to access, whether or not they are authorized to access all of the data within an entire resource 202. Through redaction, a representation 204 can be generated from a resource 202 that only contains the data that a requesting client 102 is authorized to access.

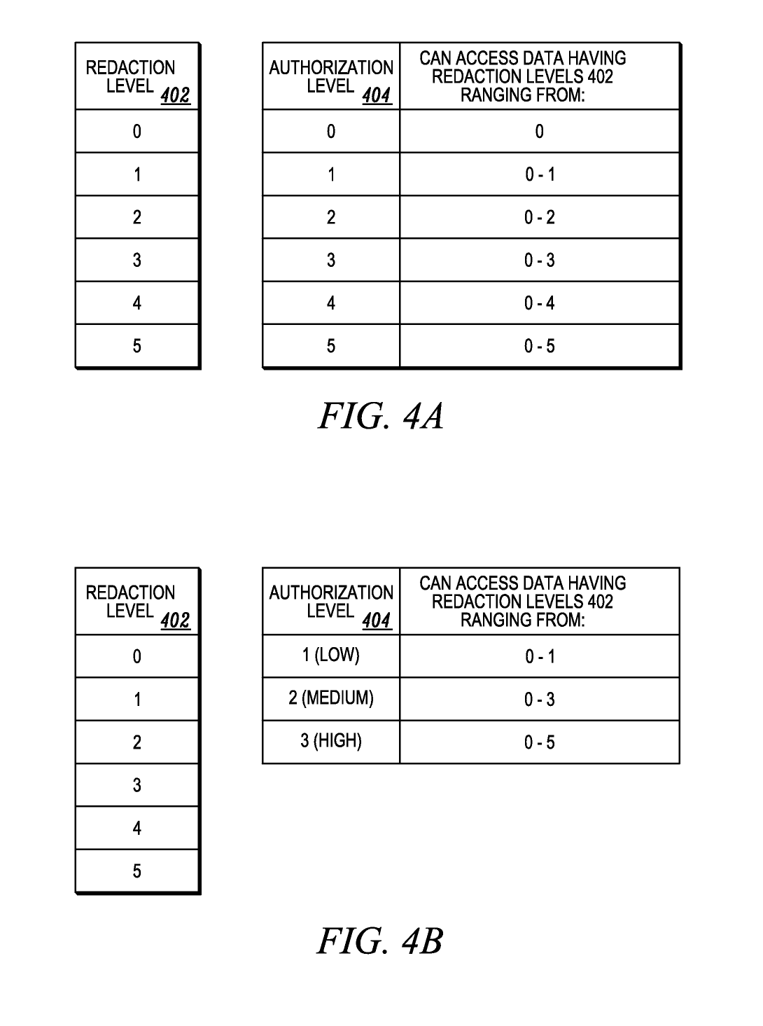

FIGS. 4A and 4B depict non-limiting examples of charts of possible redaction levels 402 and authorization levels 404. To enable redaction of resources 202 that contain data of varying sensitivity levels, each piece of data within a resource 202 can be tagged with or be assigned a redaction level 402. The redaction level 402 can indicate the sensitivity level of that piece of data. In some embodiments, the redaction levels 402 can be expressed as integers. In alternate embodiments, the redaction levels 402 can be expressed as characters, strings, colors, or any other type of indicator that can represent the sensitivity level or redaction level of data.

There can be any number of redaction levels 402. While in some embodiments the redaction level 402 can be binary to indicate whether data is sensitive or not, in other embodiments the scale can be more granular with three or more possible redaction levels 402, with each redaction level 402 indicating a specific level of sensitivity. By way of a non-limiting example, in some medical systems data in patient records can be standardized to have six redaction levels of 0, 1, 2, 3, 4, or 5, as shown in FIGS. 4A and 4B, with higher integers indicating data of higher sensitivities.

In addition to tagging or assigning data with particular redaction levels 402, each client 102 can have or be assigned an authorization level 404. In some embodiments, the authorization level 404 can be tied to a particular client 102 device, such that the client 102 maintains the same authorization level 404 regardless of the identity of the user operating the client 102. In other embodiments the authorization level 404 can be tied to a user's login credentials, such as when multiple users can log into a particular client device, so that the client 102 can change authorization levels 404 depending on which user account is logged into the client 102 and how much authority that user has been granted.

As with redaction levels 402, a client's authorization level 404 can be expressed as an integer, character, string, color, or any other indicator that represents the client's level of authority. There can be any number of possible authorization levels 404. Each authorization level 404 can be mapped to a range of redaction levels 402, such that a client 102 can be allowed to access only that data within a resource 202 that has a redaction level 402 equal to or lower than the highest redaction level 402 mapped to the client's authorization level 404.

In some embodiments, the number of authorization levels 404 can be equal to the number of redaction levels 402, as shown in FIG. 4A. In alternate embodiments, the number of authorization levels 404 can be different than the number of redaction levels 402, with each individual authorization level 404 corresponding to a particular range of redaction levels 402, or indicating a maximum allowed redaction level 402. By way of a non-limiting example, FIG. 4B depicts an embodiment in which the redaction levels 402 can range from 0 to 5, while the authorization levels can be 1 (low authority), 2 (medium authority), or 3 (high authority). In the exemplary embodiment of FIG. 4B, clients 102 having an authorization level of 1 can be authorized to access data having redaction levels 402 lower than or equal to 1; clients 102 having an authorization level of 2 can be allowed to access data having redaction levels 402 of lower than or equal to 3; and clients 102 having an authorization level of 3 can be allowed to access data having redaction levels 402 of lower than or equal to 5.

Different representations 204 of a resource 202 can be generated and be provided to clients 102 depending on the client's authorization level 404 and the redaction level 402 of each piece of data within the resource 202. Each different representation 204 can be redacted differently depending on the redaction levels 402 of the data in the resource 202. In some embodiments a plurality of representations 204 of a single resource 202 can be generated, and the plurality of representations 204 can be stored on a server 104 for later retrieval. In alternate embodiments, a representation 204 can be generated from a resource 202 upon receipt of a request 208.

In some embodiments, a different representation 204 can be generated for each redaction level 402, with each individual representation 204 being redacted to include only data from the resource 202 that was marked at or below a particular redaction level 402. By way of a non-limiting example, five separate representations 204 can be generated for a resource 202 containing data at five different redaction levels 402, with the representation 204 for each particular redaction level 402 containing data having redaction levels 402 that are lower than and/or equal to the redaction level 402 for that particular representation 204.

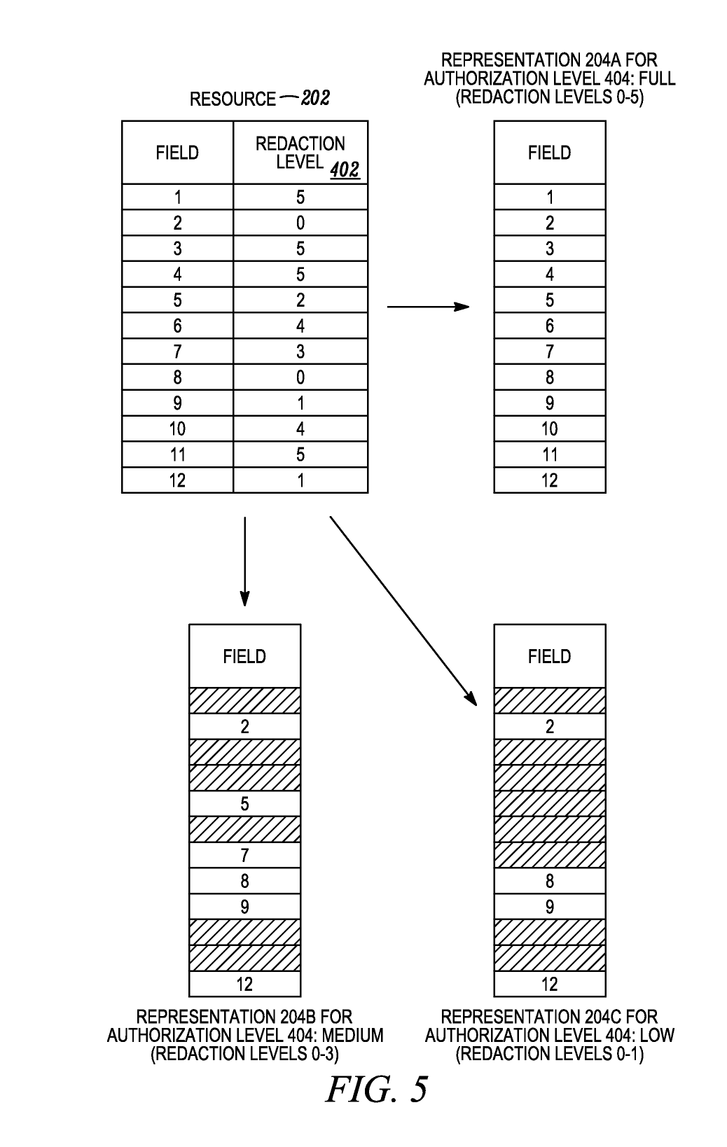

In other embodiments, a representation 204 can be generated for each possible authorization level 404, with each representation 204 containing data marked at or below the highest allowable redaction level 402 mapped to that authorization level 404. By way of a non-limiting example, FIG. 5 depicts a resource 202 having twelve data fields marked at redaction levels 402 ranging from 0 to 5. In this example, different representations 204 can be generated for each of three different authorization levels 404, with: representation 204a redacted to include all twelve fields for clients 102 having a full authorization level 404 that allows access to data marked at redaction levels 402 ranging from 0 to 5; representation 204b redacted to include six fields for clients 102 having a medium authorization level 404 that allows access to data marked at redaction levels 402 ranging from 0 to 3; and representation 204c redacted to include four fields for clients 102 having a low authorization level 404 that allows access to data marked at redaction levels 402 ranging from 0 to 1.

In still other embodiments, redacted representations 204 can be generated based on rules or search strings rather than being generated in a quantized manner according to pre-determined redaction levels 402 or authorization levels 404. In these embodiments, a policy control function running on a server 104 can analyze a resource 202 and can generate a representation 204 by including and/or excluding data from the resource 202 that satisfies a dynamic rule specified by a requesting client 102. By way of a non-limiting example, a doctor can desire to exclude information from a representation 204 that indicates a patient to be HIV positive, such as blood test results. In this example, the policy control function's redaction logic can scan through the resource 202 and generate a representation 204 that excludes data fields that include the string “HIV” or have test results related to the patient's blood cell count. By way of additional non-limiting examples, representations 204 can be generated that exclude a person's last name in situations in which user privacy is desired, or, for intelligence applications, representations 204 can be generated that exclude data related to a project with a certain code name.

When a client 102 sends a request 208 for a resource 202, the server 104 can provide the client 102 with the representation 204 of the resource 202 that contains only the data within the resource 202 that has a redaction level 402 that is equal to or lower than the redaction level 402 the client 102 is authorized to access, as indicated by the client's authorization level 404. In some embodiments, each of the plurality of representations 204 can be stored at a different URI 206, such that the client 102 can obtain a particular representation 204 of the resource 202 by requesting it from the URI 206 that corresponds to the client's authorization level 404 or requested redaction level 402. In some embodiments, the requesting client 102 can include a tag in the URI 206 to indicate the requested redaction level 402 or the client's authorization level 404. In other embodiments, after the plurality of representations 204 have been generated, each of the plurality of representations 204 can be stored at the same URI 206. In these embodiments, a client 102 can send a request 208 to that URI 206, and the server 104 can locate and fetch the appropriate representation 204 of the requested resource 202 according to client's authorization level 404 or highest authorized redaction level 402.

In some embodiments, a plurality of different types of servers 104 and/or data layers can work independently and/or in conjunction with one another to perform different functions in storing and/or updating resources 202, generating representations 204, verifying a requesting client's authorization level 404, delivering representations 204 to requesting clients 102, performing policy control functions, and/or performing other operations described herein.

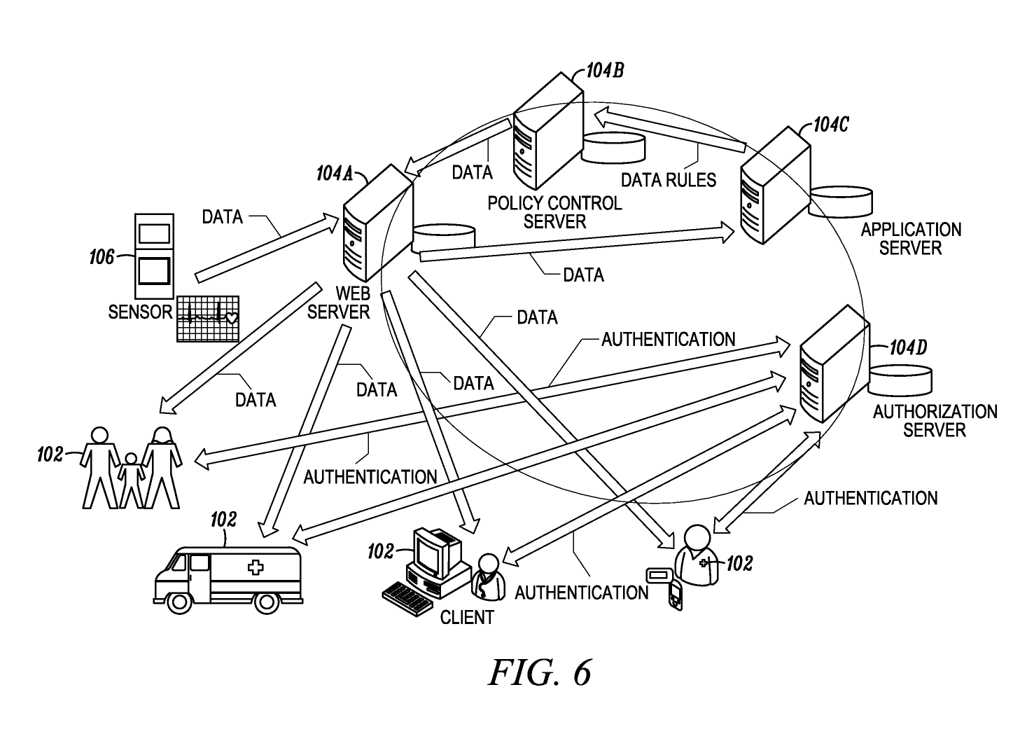

As shown in FIG. 6, in some embodiments servers 104 can be web servers 104a, policy control servers 104b, application servers 104c, and/or authorization servers 104d. In some of these embodiments, the web server 104a can be in communication with the clients 102 and sensors 106. The application server 104c can store one or more resources 202, as well as one or more rules or policies that can be used to generate redacted representations 204, such as the mapping logic that indicates the range of redaction levels 402 each authorization level 404 is allowed to access. Sensors 106 can pass data to the web server 104a, which in turn can pass that data to the application server 104c to create or update a resource 202 on the application server 104c. The resources 202 and/or rules can be passed from the application server 104c to the policy control server 104b, which can operate a policy control function to filter the data within a resource 202 and generate a redacted representation 204. The redacted representation 204 can then be passed to the web server for transport to a requesting client 102. The authorization server 104d can indicate whether a requesting client has the authority to receive a representation 204, and at what redaction level 402 or authority level 404.

In alternate embodiments, the servers 104 shown in FIG. 6 can be configured in different arrangements or have different functions, and/or one or more of the functions described herein can be performed by the same server 104. By way of a non-limiting example, in some embodiments, a policy control function can be performed by the application server 104c or the web server 104a to generate a redacted representation 204 instead of working in conjunction with a separate policy control server 104b.

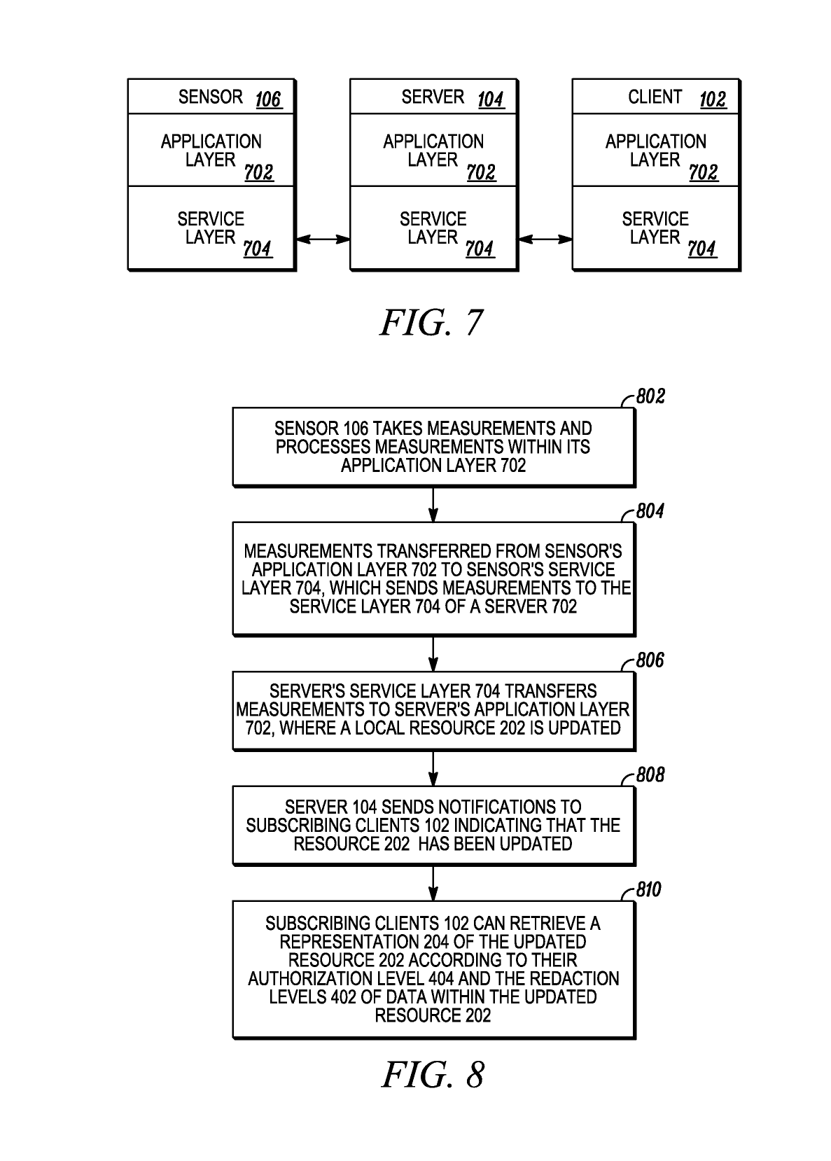

Additionally, in some embodiments different layers within the same client 102, server 104, or sensor 106 can perform different functions and/or have different levels of access to data. By way of a non-limiting example, as shown in FIG. 7, clients 102, servers 104, and/or sensors 106 can each have or be connected to an application layer 702 and a service layer 704. Programs or applications can be run on devices within an application layer 702 on the device. The service layers 704 linked to different devices can be in communication, such that data can be transferred between the service layers 704 of different devices. API primitives can be used to transfer data between the application layer 702 and a service layer 704 running on the same device and/or another device. By way of a non-limiting example, API primitives can be provided to create, update, and/or delete resources 202 stored locally on the device or remotely at another device, or to retrieve the latest representation 204 of an updated resource 202.

In some embodiments, asynchronous reporting can be implemented within a service layer 704 and/or application layer 702 on a device. In an asynchronous reporting system, clients 102 can subscribe to a device such as a server 104 or sensor 106 using a subscription request 306 to receive notifications of updates regarding a resource 202 that are stored locally on that device or remotely on another device.

FIG. 8 depicts a non-limiting example of an information cycle that follows the transmission of data from through the application layers 702 and service layers 704 of a sensor 106 to a server 104 to one or more subscribing clients 102. At step 802, a sensor 106 can take one or more measurements and process the measurements within an application layer 702 on the sensor. By way of a non-limiting example, a sensor 106 can be running an electronic health application in its application layer 702 that stores and/or processes measurements taken by the sensor 106.

At step 804, the measurements can be passed from the sensor's application layer 702 to the sensor's service layer 704. The sensor 106 can use its service layer 704 to transfer the measurement data from the sensor 106 to the service layer 704 of a server 104.

At step 806, the server's service layer 704 can pass the measurement data it received from the sensor 106 to the server's application layer 702, where it can be used to create or update a resource 202 stored within the application layer 702 of the server 104. In alternate embodiments, the local resource 202 can be updated and/or stored within the server's service layer 704.

By way of a non-limiting example, a sensor 106 can use a service layer 704 API to write into a resource 202 hosted locally at the sensor's service layer 704, and can then use service layer interfaces and communications networks, such as HTTP, TCP/IP, and/or wired or wireless networks, to pass the measurement data to a server's service layer 704, for example running on a web server 104a. The server 104 can populate or update a network-side resource 202 that represents the sensor 106. In some embodiments, the application layer 702 of the server 104 can be notified that new data is available for retrieval.

In embodiments in which subscription or notification features are present, at step 808 the server 104 can send notifications to clients 102 that have subscribed and indicated their interest in receiving notifications about updates regarding the network side resource 202.

At step 810, after receiving a notification from the server 104 that a resource 202 has been updated, the subscribing clients 102 can retrieve a redacted representation 204 of the resource 202 depending on the client's authorization level 404 and the redaction level 402 of the data within the updated resource 202.

In some embodiments, encryption and decryption can be used when data is transferred between the application layers 702 and/or service layers 704 of one or more devices. When it is desired that data being processed at a device's application layer 702 be kept private from the device's service layer 704, the data can be encrypted within the device's application layer 702 before entering the device's service layer 704 to avoid exposure to service layer entities, including a client's service layer 704, a server's service layer 704, or any other service layer proxies or servers. In some embodiments, regulations can require that certain data be kept within application layers 702 and be protected from being accessed within service layers 704. By way of a non-limiting example, in some situations regulations can be in place that require health data being processed as part of a health application, for instance a patient monitoring application running on a sensor 106, be kept within the device's application layer 702 so as to be protected from the device's service layer 704. Encryption can be used to transfer data through the service layers 704 of devices without allowing sensitive information to be accessed by the service layers 704.

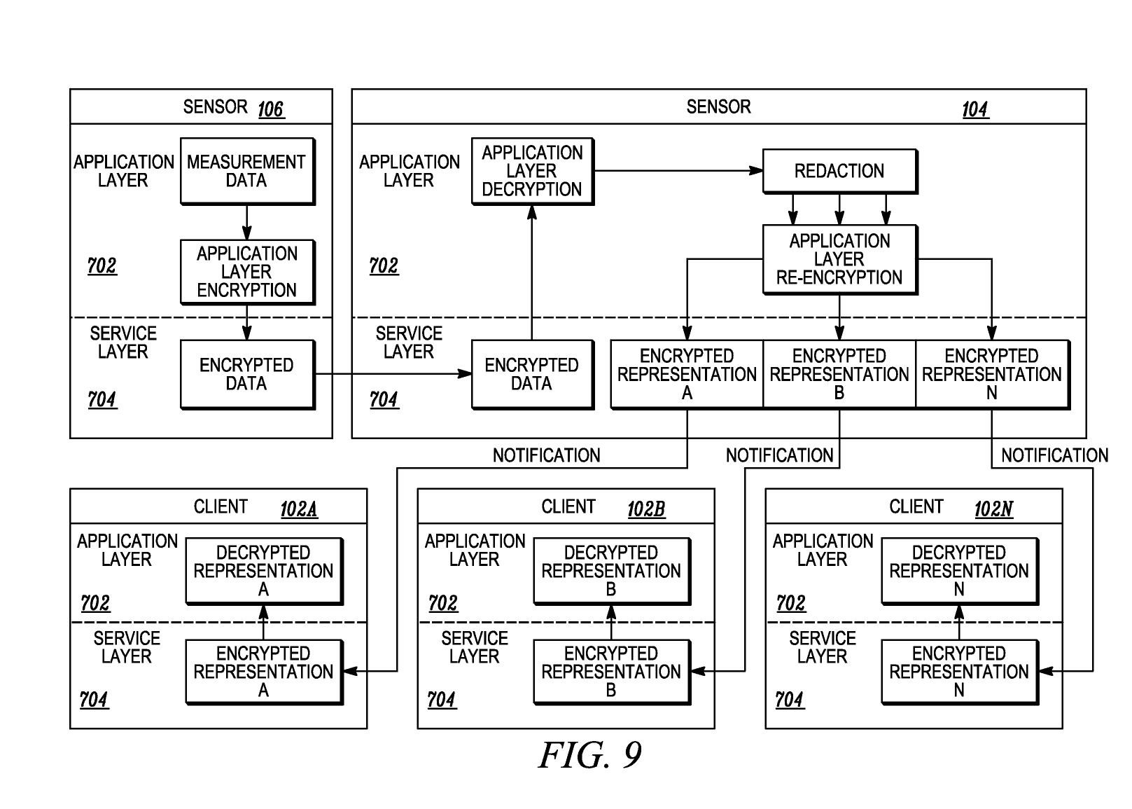

By way of a non-limiting example, FIG. 9 depicts a sensor 106 that stores its measurements in an application layer 702 within the sensor 106. The measurements can be encrypted within the sensor's application layer 702, and the encrypted measurements can be passed to the sensor's service layer 704. The sensor's service layer 704 can then transmit the encrypted measurements to the service layer 704 of a server 104, which can in turn pass the encrypted measurements to the server's application layer 702 for decryption. The decrypted measurements can be used within the server's application layer 702 to create and/or update a resource 202 stored on the server 104. Redaction of the resource 202 can be performed within the server's application layer 702 to generate redacted representations 204 depending on the redaction level 402 of the resource's data and the authorization levels 404 of clients 102, and the redacted representations 204 can be encrypted within the server's application layer 702. The encrypted representations 204 can be passed to the server's service layer 704, which can transmit the encrypted representations 204 and/or notifications to the service layer 704 of one or more clients 102. The client's service layer 704 can pass the encrypted representations to the client's application layer 702 for decryption and use.

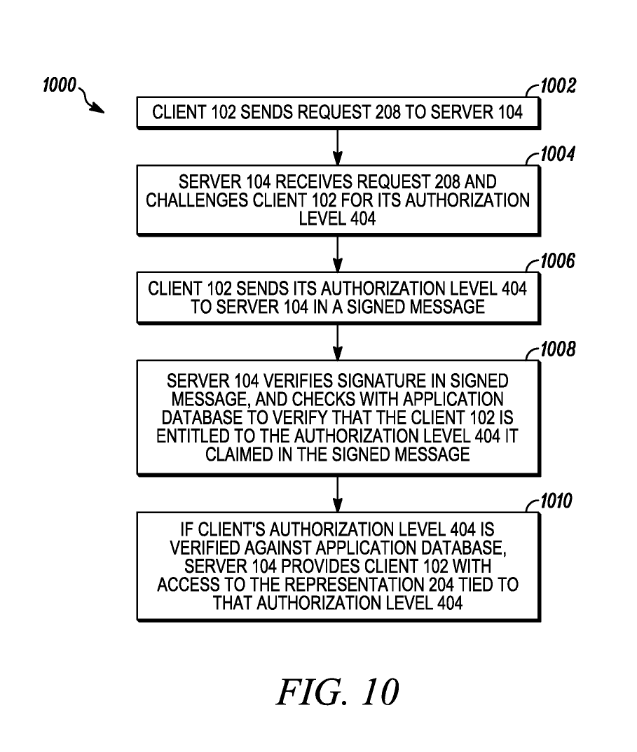

In some embodiments, when a server 104 receives a request 208 for a resource 202, the server 104 can use an authorization process 1000 to determine the client's authorization level 404 and determine whether the client 102 actually has authority to access a particular requested representation 204, or to determine which representation 204 to provide to the client 102. FIGS. 10, 11, and 12 depict exemplary embodiments of an authorization process 1000. In some embodiments, an authorization process 1000 can be performed by or in conjunction with an authorization server 104d, while in other embodiments the authorization process 1000 can be performed by any other type of server 104.

FIG. 10 depicts a flow chart of a first exemplary embodiment of an authorization process 1000. In this exemplary embodiment, at step 1002 a client 102 can send a request 208 for a resource 202, such as a retrieve request 302, update request 304, or subscribe request 306, to a server 104 without indicating a desired redaction level 402 or a claimed authorization level 404. At step 1004, the server 104 can receive the request 208 and then send a message to the client 102 that challenges the client 102 for the client's authorization level 404. At step 1006, the client 102 can respond by sending a claimed authorization level 404 in a message that is signed with a credential known to the server 104. At step 1008, the server 104 can verify the signature in the message, and can consult an application database for the requesting client's profile to determine whether the requesting client 102 is actually entitled to the authorization level 404 found in its signed message. By way of a non-limiting example, the application database can be stored on an authorization server 104d. At step 1010, if the server 104 verifies that the authorization level 404 claimed by the client 102 is accurate for that client 102 according to the application database, the server 104 can provide the client 102 with access to the appropriate representation 204 for the client's verified authorization level 404.

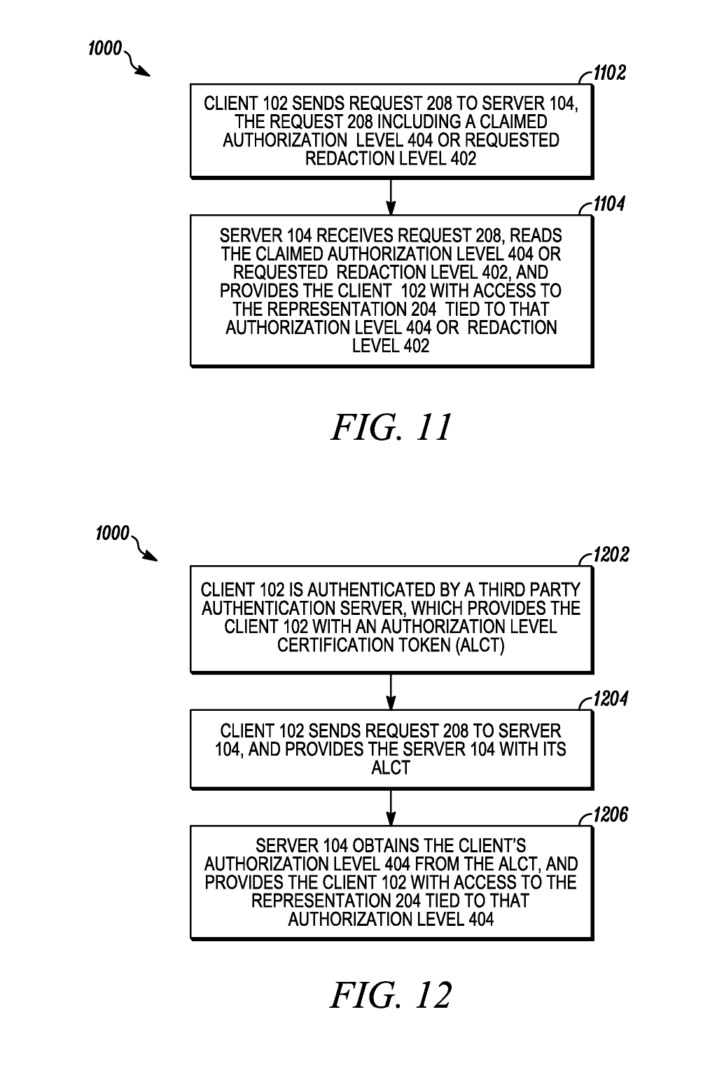

FIG. 11 depicts a flow chart of a second exemplary embodiment of an authorization process 1000. In this exemplary embodiment, at step 1102 a client 102 can send a request 208 for a resource 202 to the server 104, and can indicate a claimed authorization level 404 or requested redaction level 402 as part of the request. By way of non-limiting examples, a field in the request's header or a query string in a URI 206 can be used to indicate the claimed authorization level 404 or the requested redaction level 402. In some embodiments, a field in the request 208 that indicates the client's authorization level 404 or requested redaction level 402 can be signed with a credential known to the server 104. In some embodiments, the server 104 can verify the signed credential in the request 208 to validate the request 208 prior to providing access to the appropriate representation 204. At step 1104, the server 104 can use the provided authorization level 404 or requested redaction level 402 to provide the client 102 with access to the appropriate representation 204 for the client's authorization level 404 or requested redaction level 402.

FIG. 12 depicts a flow chart of a third exemplary embodiment of an authorization process 1000. In this exemplary embodiment, at step 1202 a client 102 can be authenticated by a third party authentication server and obtain an authorization level certification token (ALCT). The ALCT can be signed by the third party authentication server such that a server 104 storing a resource 202 or representation 204, such as an application server 104c, can verify the ALCT's signature. By way of a non-limiting example, the ALCT can be signed using a certified public and private key pair, or using a key that is shared with an application server 104c. In some embodiments, the ALCT can also include a unique and tamper-proof client identifier and unique application identifier to prevent theft of the ALCT by other clients 102. By way of a non-limiting example, in some embodiments the ALCT can be PRF(TSK, Client_ID, AL, [RL], Time_Stamp, [validity], [S_ID], [TSK_ID]), where PRF is a pseudorandom function, TSK is a token signing key, Client_ID is a unique identifier for the client 102, AL is the authorization level 404, RL is the redaction level 402, Time_Stamp is the time the token was signed, validity is the length of time for which the token is valid following the time of signing, S_ID is the signer's identification, and TSK_ID is an identifier for the token signing key, with the parameters marked within brackets being optional parameters in this non-limiting example. By providing the ALCT, the authentication server can be asserting that it has verified the Client_ID and AL (the client's authorization level 404). In some embodiments in which the ALCT also includes the RL (redaction level 402), the authorization server can also be asserting that it has verified that the client associated with the Client_ID has authority to access data at that redaction level 402, such as if the authentication server has access to the mapping logic relating redaction levels 402 to authorization levels 404.

After obtaining the ALCT at step 1202, at step 1204 the client 102 can send a request 208 for a resource 202 to a server 104, such as an application server 104c. The client 102 can present the ALCT to the server 104 when making the request 208 for the resource 202 during step 1204. In some embodiments, the ALCT can be sent to the server 104 using HTTP as part of an authorization or cookie header.

At step 1206, the server 104 can obtain the client's authorization level 404 from the ALCT and can then return the representation 204 that corresponds to the client's authorization level 404, or a URI 206 pointing to the appropriate representation 204 for the client's authorization level 404.

After a server 104 has determined and/or authenticated the client's authorization level 404, for example by using an authorization process 1000, the server 104 can return the appropriate representation 204 directly to the client 102, or can provide the client 102 with the URI 206 for the appropriate representation 204 so that the client 102 can retrieve the representation 204 from the URI 206. In some embodiments, the representation 204 can be encrypted for transmission to the client 102. As discussed above, in some embodiments one or more devices such as servers 104, clients 102, and/or sensors 106 can have application layers 702 that handle unencrypted data and service layers 704 that handle encrypted data.

In some embodiments, a representation 204 can be encrypted using a pre-shared key. The pre-shared key can be distributed to all clients 102 that have a particular authorization level 404 before a request 208 is sent, or can be distributed to each client 102 when authorization level 404 assertion or authentication is complete but before the client 102 sends a request 208 to a server 104. In some embodiments, the pre-shared key can be established as part of a secure session, such as a Transport Layer Security (TLS) or Secure Sockets Layer (SSL) session. By way of a non-limiting example, a pre-shared key established as part of a TLS session can be PSK_TLS.

In some embodiments an ALCT, as described with respect to FIG. 12, can be used as a pre-shared key. The client 102 can possess the ALCT after receiving it from the third party authentication server during step 1002. A server 104 can fetch the ALCT with an authentication server, or can verify the ALCT with the authentication server before establishing a secure session.

In alternate embodiments, the representation 204 can be encrypted using a key that is established as part of a secure session, such as a TLS session, before or after any portion of an authorization process 1000 has completed. By way of a non-limiting example, representation 204 can be encrypted as part of a TLS session established after a client's authorization level 404 has been verified, because TLS does not require storage of a pre-shared key. In still other embodiments, an ALCT can be verified after a TLS session is established using standard TLS processes. If the ALCT verification fails, the TLS session can be dropped before the redacted representation 204 is sent to the client 102.

In some embodiments, a server 104 can send the client 102 a URI 206 for the appropriate representation 204, rather than sending the actual representation 204 directly. In these embodiments, the client 102 can receive the URI 206 and fetch the appropriate redacted representation 204 from that URI 206. In some embodiments, the redacted representation 204 can be encrypted using a pre-shared key such as PSK_TLS as described above.

In some embodiments, a server 104 can use a different encryption key for each of the different representations 204 that correspond to different redaction levels 402 or authorization levels 404. In these embodiments, the server 104 can include a key identifier in a response to the requesting client 102, such that the client 102 can fetch the proper decryption key based on the key identifier. In some embodiments, the key identifier can be an encryption key token that can be passed to an authentication server that previously issued an authorization token, such as an ALCT as described with respect to FIG. 12, to the requesting client 102. The requesting client 102 can receive the encrypted representation 204 and an encrypted key token from the server 104, and can then pass the encrypted key token to the authentication server. The authentication server can decrypt the key token to determine the encryption key, and then return the appropriate encryption key to the requesting client 102 such that the requesting client 102 can use the encryption key to decrypt the encrypted representation 204.

In some embodiments, the requesting client 102 can store the representation 204 only in the encrypted form it receives from the server 104, such that the data within the representation 204 can only be accessible to the client 102 for as long as the client 102 holds a valid encrypted key token. By way of a non-limiting example, the encrypted key token can have an expiration time or valid time duration, such that the data within an encrypted representation 204 is only accessible to a client 102 during a limited time period. In some embodiments, the validity duration of the encrypted key token can be linked to the authorization level 404 of the client 102.

In other embodiments, a single encryption key can be used for the representations 204 for all redaction levels 402, and an authorization level-based authorization process 1000 can be used to verify that a particular client 102 has authority to access a particular representation 204. In still other embodiments, multiple encryption keys can be used, one for each redaction level 402. By way of a non-limiting example, symmetric keys can be used with each different key pair for each redaction level 402.

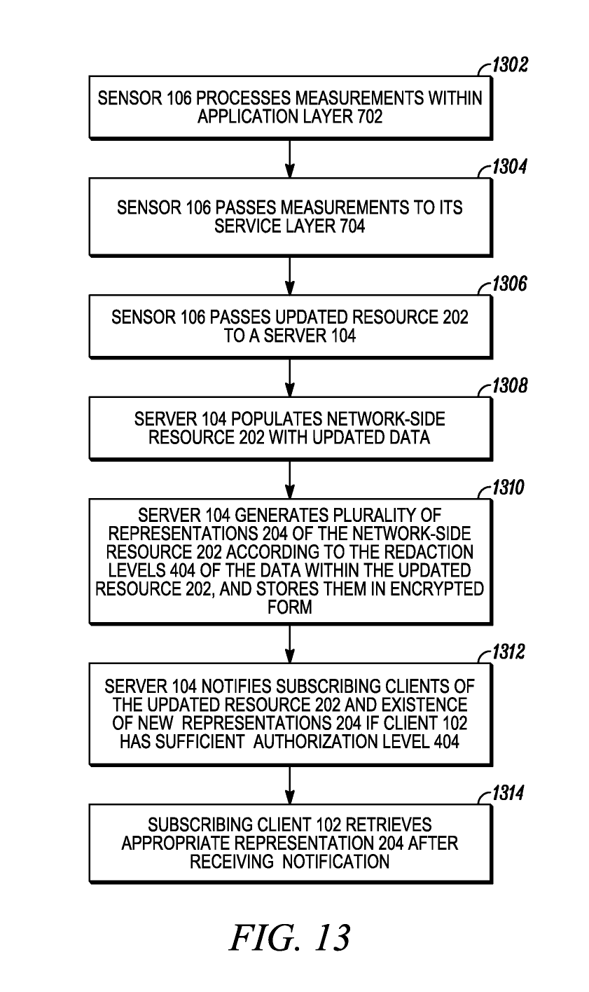

FIG. 13 depicts a flow chart of first non-limiting exemplary scenario for use of the system described herein. When redaction of resources 202 is desired and clients 102 can have different authorization levels 404, notifications about updates to a resource 202 can be provided to subscribing clients 102 authorized to receive the updates depending on each subscribing client's authorization level 404 using the process of FIG. 13.

At step 1302, a sensor 106 can encrypt measurement data with an application-specific key within the sensor's application layer 702. In some embodiments, the measurement data can also be signed. The application-specific key can be a key shared between or understood by both the sensor's application layer 702 and a server's application layer 702. In some embodiments, the application-specific key can be provided by a provider or developer of a program or application running within the sensor's application layer 702. In other embodiments, the application key can be generated from a device key.

At step 1304, the sensor 106 can pass encrypted measurement data through an API to the sensor's service layer 704, or a service layer at a geographically or topologically adjacent gateway. In some embodiments, such as when the service layer 704 is hosted on a separate device or component, a local resource 202 at the separate device or component can be updated with the measurement data within its application layer 702.

At step 1306, the sensor's service layer 704 can pass the updated resource 202 to a server 104 using a connection to the server's service layer 704 over a network. In some embodiments, the updated resource 202 can be encrypted such that the service layer 704 can carry the updated resource's data in an opaque manner. In some embodiments, the service layer connection can provide additional security protection, such as those provided by TLS/SSL or another any other encryption scheme.

At step 1308, the server's service layer 704 can populate a network-side resource 202 with the encrypted data it received. The server's service layer 704 can notify the server's application layer 702 that the network-side resource 202 has been updated. The server's application layer 702 can fetch the encrypted data from the network-side resource 202 in the server's service layer 704 through an interface. In some embodiments, the interface can be a local internal API when the server's service layer 704 and application layer 702 are on the same machine. In other embodiments, the interface can be a protocol such as HTTP or HTTPS when the service layer 704 and application layer 702 are on different hardware components. In some embodiments, the encrypted data from the network-side resource 202 can be decrypted within the server's application layer 702. If the data was also signed, the application layer 702 can verify the signatures prior to removing the encryption.

At step 1310, the server 104 can generate a plurality of representations 204 within its application layer 702, one for each redaction level 402. Each of the redacted representation 204 generated can be encrypted within the application layer 702, and the encrypted file can have a tag indicating the redaction level 402 that was used to generated the representation 204. In some situations and/or embodiments, the tag indicating the redaction level 402 can be left unencrypted, such as if the redaction level 402 itself is not considered sensitive material. In other situations and/or embodiments in which the redaction level 402 is itself considered sensitive material, the server's application layer 702 can include the tag indicating the redaction level 402 inside the representation 204 prior to encryption. In these situations, the server's application layer 702 can use mapping logic to determine the authorization level 404 sufficient to access the redaction level 402 of the representation, and can tag the representation 204 with the authorization level 404. The authorization level 404 tag can be left unencrypted. Through this process, only a client 102 having the appropriate authorization level 404 can see the encrypted redaction level 402.

In some embodiments, a different encryption key can be used to encrypt each generated representation 204. In some embodiments that use different encryption keys for each representation 204, key identifiers can be added to the representation 204, such that clients 102 can identify the proper key to use during decryption. In alternate embodiments, the same encryption key can be used to encrypt each generated representation 204. If integrity protection is desired, the server 104 can also sign each of the generated representations 204 within the application layer 702 after they are encrypted.

The server's application layer 702 can pass all of the generated representations 204, along with the tags indicating the representations' respective redaction level 402 or authorization level 404 to the server's service layer 704, where it can update the network-side resource 202 with the representations 204 received from server's application layer 702, along with their tags. In some embodiments, an interface such as HTTP can be used to pass the representations and tags to the server's service layer 704, and the encrypted data can be passed as an opaque binary payload while the tags can be passed inside clear headers. By way of a non-limiting example, in some embodiments the tags can be passed inside an HTTP content header.

At step 1312, the server 104 can send notifications to clients 102 that have subscribed to receive information about updates to the resource 202. The clients 102 can have previously indicated their authorization levels 404 when subscribing to the resource 202, and the server's service layer 704 can maintain a database or list of the subscribing clients 102 and their authorization levels 404.

Notifications can be sent to clients 102 based on each client's authorization level 404. By way of a non-limiting example, the server's service layer 704 can look at each subscriber's authorization level 404 and compare it to the tagged authorization level 404 of each received representations 204. If the subscriber's authorization level 404 is less than that tagged authorization level 404, the subscribing client 102 is not authorized to access that particular representation and no notification will be sent. If the subscribing client's authorization level 404 is greater than or equal to the tagged authorization level 404, the subscribing client 102 is authorized to access that particular representation 204 and the server's service layer 704 can send a notification to the subscribing client 102. In some situations, a client 102 having a lower authorization level 404 can receive fewer notifications than a client 102 with a higher authorization level 404, even if there was an update to the original resource 202.

At step 1314, when a subscribing client 102 receives a notification that a resource 202 has been updated, the subscribing client 102 can send a request 208 for the resource 202. The request 208 can go either to the service layer 704 of the server 104 that is storing the resource 202, or to a different server 104 that dedicated to receiving requests 208, which can pass the request to other servers 104. The server's service layer 704 can respond to the subscribing client's request 208 with the appropriate representation 204 for the client's authorization level 404. As discussed above, in some embodiments an authorization process 1000 can be performed to determine that the client 102 actually has the authorization level 404 it claims. When the server 104 fetches the appropriate representation 204, the representation 204 can be encrypted as discussed above and sent to the subscribing client 102.

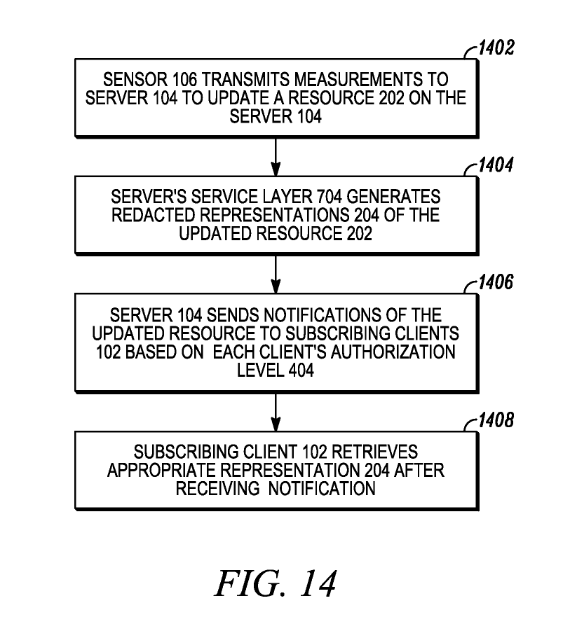

FIG. 14 depicts a second exemplary use case. When redaction of representations 204 is desired but the data at a device's application layer 702 does not need to be kept private from the device's service layer 704, redaction can be implemented at the service layer 704 using the process of FIG. 14. In some embodiments, a secure API can be in place between the application layers 702 and service layers 704 of any device, for example so that a sensor's application layer 702 can send data down the service layer 704 at the sensor 106 or a gateway through the secure API.

At step 1402, a sensor 106 can transmit its measurements to the service layer 704 of a server 104 to update a resource 202. At step 1404, separate representations 204 of the resource 202 for each redaction level 402 can be generated within the server's service layer 704. Each representation 204 can be tagged with the authorization level 404 that would be sufficient to access the data within that representation 204.

At step 1406, the server 104 can send notifications to subscribing clients 102 according to their authorization level 404. In some embodiments, a server's service layer 704 can coordinate with an application server 104c or policy control server 104b to determine the policies for access rights and authorization levels 404 when sending notifications and/or generating redacted representations 204. At step 1408, each subscribing client 102 that receives a notification can access the redacted representation 204 that is appropriate for its authorization level 404.

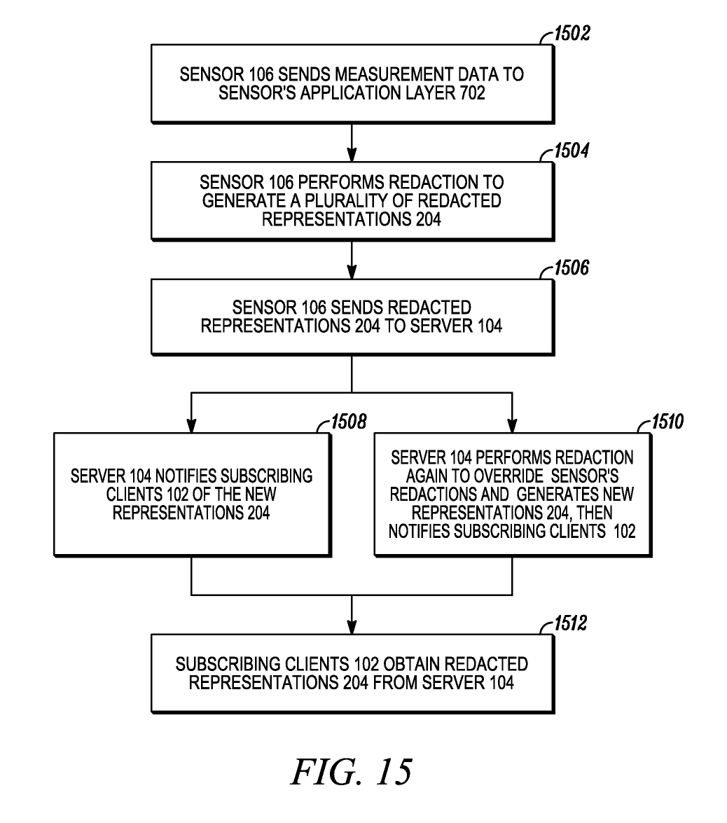

FIG. 15 depicts a third exemplary use case. In some alternate embodiments, a sensor 106 can itself have enough processing power and memory to store redaction policies and redact a local resource 202 to generate a plurality of redacted representations 204.

At step 1502, the sensor's sensor's measurement or monitoring functionality can send data to the sensor's application layer 702. At step 1504, redaction policies can be applied at the sensor's application layer to determine sensitivity levels of each piece of data within the measurements. The sensor 106 can generate one or more redacted representations 204 within the application layer 702. In some embodiments, the server's application layer 702 can encrypt each representation 204 with one or more keys during step 1504. By way of a non-limiting example, the encryption keys can be pre-assigned, with one key per redaction level 402 being previously generated from a master key generated by or provided to the sensor 106.

At step 1506, the sensor can pass the redacted representations 204 to other parts of the infrastructure, such as servers 104 and/or clients 102. In some embodiments in which the representations are encrypted during step 1504, the sensor's application layer 702 can pass the encrypted representations 204 to its service layer 704, and from there the representations 204 can be transmitted to a server 104.

At step 1508, if the representations have been transmitted to a server, the server's service layer 704 can send notifications to subscribing clients 102 that new representations 204 are available according to the subscribing client's authorization levels 404.

As an alternative to step 1508, at step 1510 the server's service layer 704 can send the representations 204 it has received from the sensor 106 to the server's application layer 702, which can decrypt the representations 204. The resource 202 can be recreated from the decrypted representations 204, and redaction can be performed again within server's application layer 702 to override any redactions performed by the sensor 106. By way of a non-limiting example, if the sensor 106 generated redacted representations 204 according to an outdated version of the mapping logic relating redaction levels 402 to authorization levels 404, the server 104 can redact the resource 202 again using an updated version of the mapping logic. After performing redaction again, the server 104 can send notifications to subscribing clients 102 according to the subscribing client's authorization levels 404.

At step 1512, the subscribing clients 102 that received a notification during steps 1508 or 1510 can access the appropriate representation 204 for their authority level 404 from the server 104.

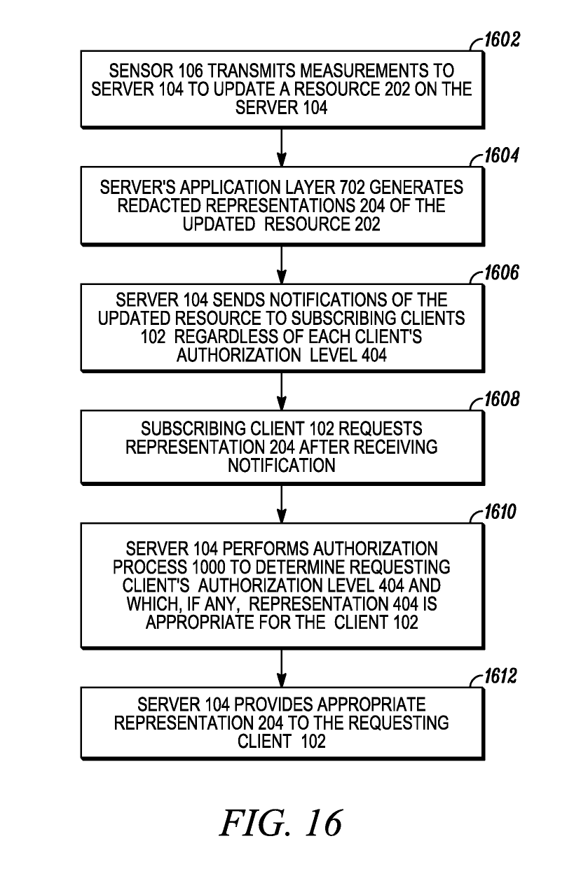

FIG. 16 depicts a fourth exemplary use case. In some embodiments, a server 104 can allow subscribing clients 102 to subscribe to the server's application layer 702 directly, for example if the server's service layer 704 does not support tagging of opaque or encrypted representations 204 for particular redaction levels 402, authorization levels 404, or other characteristics, such that the server's service layer 704 would not be able to perform authentication level-based subscription notifications as described above.

At step 1602, a sensor 106 can transmit its measurements to the service layer 704 of a server 104 to update a resource 202. At step 1604, separate representations 204 of the resource 202 for each redaction level 402 can be generated within the server's application layer 702. Each representation 204 can be tagged with the authorization level 404 that would be sufficient to access the data within that representation 204.

At step 1606, the server's service layer 704 can notify any or all subscribing clients 102 that there has been an update to the resource 202, regardless of whether the subscribing device 102 has the authorization level 404 to access a representation 204 that includes the updated data. The notification can include the URI 206 of the server's application layer 702. At step 1608, subscribing clients 102 can receive the notification, and can contact the server's application layer 702 at the URI 206 to request a representation 204.

At step 1610, an authorization process 1000 can be performed to determine whether the subscribing client 102 has authority to access any of the representations 204 at the server 104, and if so, which particular representation 204 should be provided to the client 102 based on the client's authorization level 404. At step 1612, the representation 204 determined to be appropriate for a particular subscribing client 102 can be transferred to the client 102.

In some situations, the urgency or criticality of data can be more relevant than the data's sensitivity level. By way of a non-limiting example, anomalies in a patient's vital signs detected by medical monitoring devices can have life-threatening implications, and different personnel or entities can be notified depending on the danger of a detected anomaly. For instance, the detection of a small abnormality can trigger a notification to a family member or care coordinator, while detection of a life-threatening situation can trigger notification of emergency medical response units. In these embodiments, urgency levels 1702 can be used in place of redaction levels 402, and responsiveness levels 1704 can be used in place of authorization levels 404 in any of the operations described above.

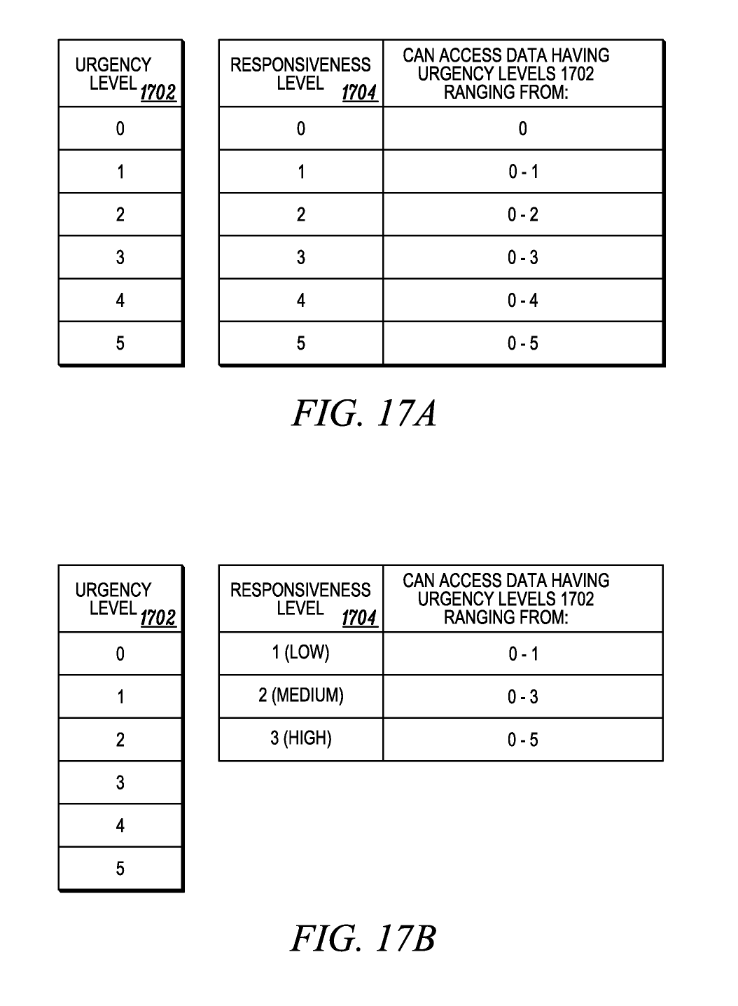

FIGS. 17A and 17B depict non-limiting examples of charts of possible mapping between urgency levels 1702 and responsiveness levels 1704. Data in a resource 202 can be tagged with an urgency level 1702. Urgency levels 1702 can be similar to redaction levels 402, with the urgency level 1702 expressed as an integer or other indicator, with higher urgency levels 1702 assigned to data that indicates a more critical situation. Responsiveness levels 1704 can be assigned to clients 102. Responsiveness levels 1704 can be similar to authorization levels 404, with the responsiveness level 1704 expressed as an integer or other indicator, with higher responsiveness levels 1704 assigned to more responsive clients 102, clients 102 with more resources, and/or clients 102 with higher expertise. By way of a non-limiting example, paramedics can be assigned a higher responsiveness level 1704 than a family member that has no medical training Similar to the mapping of redaction levels 402 to authorization levels 404 described above, the urgency levels 1702 can be mapped to responsiveness levels 1704 to determine which clients 102 can access data at which urgency levels 1702, as shown in FIGS. 17A and 17B.

Similar to the processes described, a sensor's application layer 702 can send data through service layers 704 to a server's application layer 702. In some embodiments, the data can be encrypted before being passed to the service layers 704. The server's application layer 702 can tag data elements with urgency levels 1702, and can create multiple representations 204 of the resource 202, one for each urgency level 1702 or responsiveness level 1704. The server's service layer 704 can send notifications to subscribing clients 102 regarding updates of a resource 202 based on the subscribing client's responsiveness level 1704.

In other embodiments, urgency levels 1702 and responsiveness levels 1704 can be used to override normal privacy policies, such as those involving redaction levels 402 and/or authorization levels. In these embodiments or situations, the desire to preserve life can be prioritized over the need to preserve privacy. When an urgent situation is not occurring, clients 102 can access redacted representations 204 based on their authorization level 404 and the redaction level 402 of the representation 204 as described above, or can otherwise access records, representations 204, or resources 202 according to any privacy policy. However, when an urgent situation occurs, certain clients 102 can be allowed to access more of a resource 202 than they normally could access, and/or urgent resource updates can be sent without encryption or without being tagged with an urgency level 1702.

In these embodiments, the sensor's application layer 702 can be preconfigured with policies or logic to determine which events can override other policies. When the sensor's service layer 704 receives a tagged update, it can forward the tagged resource update to the server's service layer 704. The server's service layer 704 can generate notifications for subscribing clients 102 based on the urgency level 1702 of the data and the subscribing client's responsiveness level 1704, according to the mapping of urgency level 1702 to responsiveness level 1704.

The service layer 704 can invoke quality of service mechanisms at lower communication layers to enable priority routing and handling of urgent data. By way of non-limiting examples, quality of service mechanisms can be the Differentiated Services (DS) field in IPv4 or IPv6, or other priority routing mechanisms implemented at access network technologies. The service layer 704 can use the urgency level 1702 of the update to determine the quality of service mechanism to use such that the update is delivered with as little delay as possible, such as without deep application-level packet inspection.

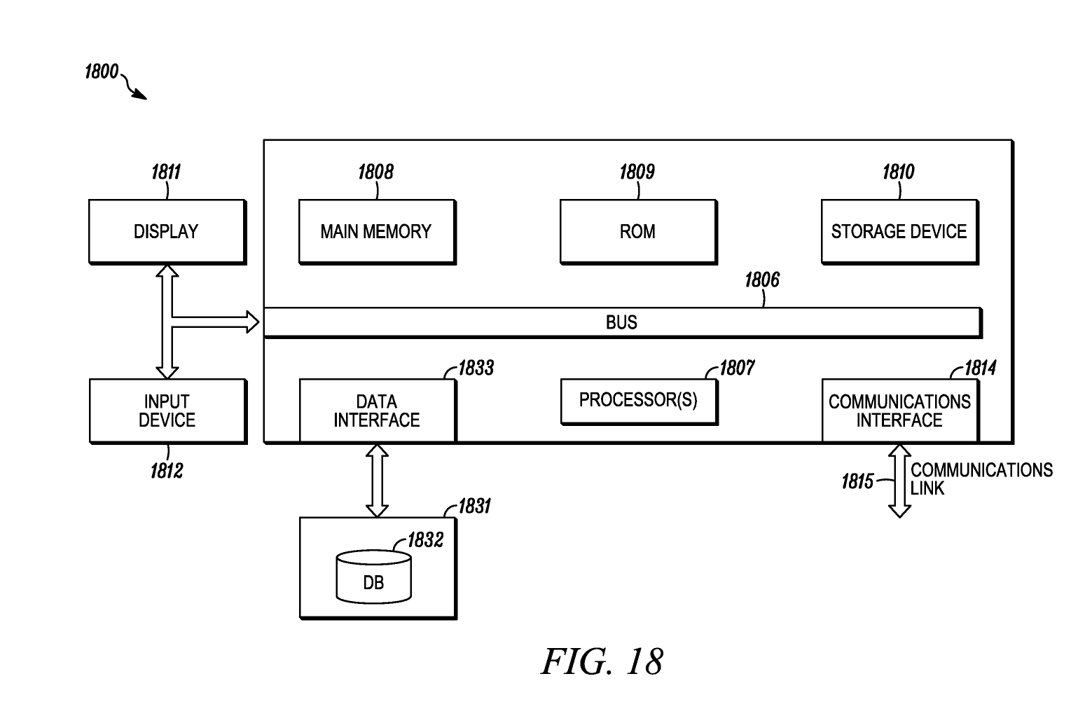

The execution of the sequences of instructions required to practice the embodiments may be performed by a computer system 1800 as shown in FIG. 18. Any or all of the clients 102, servers 104, and/or sensors 106 can be or comprise a computer system 1800. In an embodiment, execution of the sequences of instructions is performed by a single computer system 1800. According to other embodiments, two or more computer systems 1800 coupled by a communication link 1815 may perform the sequence of instructions in coordination with one another. Although a description of only one computer system 1800 may be presented herein, it should be understood that any number of computer systems 1800 may be employed.

A computer system 1800 according to an embodiment will now be described with reference to FIG. 18, which is a block diagram of the functional components of a computer system 1800. As used herein, the term computer system 1800 is broadly used to describe any computing device that can store and independently run one or more programs.

The computer system 1800 may include a communication interface 1814 coupled to the bus 1806. The communication interface 1814 provides two-way communication between computer systems 1800. The communication interface 1814 of a respective computer system 1800 transmits and receives electrical, electromagnetic or optical signals, that include data streams representing various types of signal information, e.g., instructions, messages and data. A communication link 1815 links one computer system 1800 with another computer system 1800. For example, the communication link 1815 may be a LAN, an integrated services digital network (ISDN) card, a modem, or the Internet.

A computer system 1800 may transmit and receive messages, data, and instructions, including programs, i.e., application, code, through its respective communication link 1815 and communication interface 1814. Received program code may be executed by the respective processor(s) 1807 as it is received, and/or stored in the storage device 1810, or other associated non-volatile media, for later execution.

In an embodiment, the computer system 1800 operates in conjunction with a data storage system 1831, e.g., a data storage system 1831 that contains a database 1832 that is readily accessible by the computer system 1800. The computer system 1800 communicates with the data storage system 1831 through a data interface 1833.

Computer system 1800 can include a bus 1806 or other communication mechanism for communicating the instructions, messages and data, collectively, information, and one or more processors 1807 coupled with the bus 1806 for processing information. Computer system 1800 also includes a main memory 1808, such as a random access memory (RAM) or other dynamic storage device, coupled to the bus 1806 for storing dynamic data and instructions to be executed by the processor(s) 1807. The computer system 1800 may further include a read only memory (ROM) 1809 or other static storage device coupled to the bus 1806 for storing static data and instructions for the processor(s) 1807. A storage device 1810, such as a magnetic disk or optical disk, may also be provided and coupled to the bus 1806 for storing data and instructions for the processor(s) 1807.

A computer system 1800 may be coupled via the bus 1806 to a display device 1811, such as an LCD screen. An input device 1812, e.g., alphanumeric and other keys, is coupled to the bus 1806 for communicating information and command selections to the processor(s) 1807.

According to one embodiment, an individual computer system 1800 performs specific operations by their respective processor(s) 1807 executing one or more sequences of one or more instructions contained in the main memory 1808. Such instructions may be read into the main memory 1808 from another computer-usable medium, such as the ROM 1809 or the storage device 1810. Execution of the sequences of instructions contained in the main memory 1808 causes the processor(s) 1807 to perform the processes described herein. In alternative embodiments, hard-wired circuitry may be used in place of or in combination with software instructions. Thus, embodiments are not limited to any specific combination of hardware circuitry and/or software.

Although the present invention has been described above with particularity, this was merely to teach one of ordinary skill in the art how to make and use the invention. Many additional modifications will fall within the scope of the invention, as that scope is defined by the following claims.

What is claimed:

1. A method for providing redacted representations of data, comprising:
hosting a resource on a server, said resource comprising a plurality of data pieces each tagged with one of a plurality of redaction levels;
generating a plurality of redacted representations of said resource at said server, wherein each of said plurality of redacted representations is designated for one of a plurality of authorization levels each corresponding to a different range of redaction levels, and the redacted representation for a particular one of said plurality of authorization levels containing one or more of said plurality of data pieces that are tagged with one of a plurality of redaction levels that falls within the range of redaction levels for that particular one of said plurality of authorization levels;
receiving a request from a client, said request comprising a claimed authorization level; and
providing said client with one of said plurality of redacted representations that is designated for the one of said plurality of authorization levels that matches said claimed authorization level.

2. The method of claim 1, further comprising:
notifying one or more subscribing clients that a particular one of said plurality of redacted representations is available at said server when said one or more subscribing clients has a particular one of said plurality of authorization levels that is associated with said particular one of said plurality of redacted representations.

3. The method of claim 1, further comprising:
verifying that said client is entitled to said claimed authorization level in said request by checking said claimed authorization level against a stored authorization level for said client in an application database.

4. The method of claim 1, further comprising verifying that said client is entitled to said claimed authorization level in said request by:
obtaining a token from said client that comprises said client's authorization level, wherein said client obtained said token from an authentication server after having its identity verified by said authentication server; and
determining said client's authorization level from said token to verify that said client is entitled to said claimed authorization level in said request.

5. The method of claim 1, wherein said resource and said plurality of representations are stored within an application layer at said server, and said server encrypts one of said plurality of representations prior to sending it to said client through a service layer at said server.

6. The method of claim 1, further comprising:
receiving at said server one or more measurements from a sensor; and
updating said resource with said one or more measurements prior to generating said plurality of redacted representations.

7. The method of claim 6, wherein said measurements are encrypted when received from said sensor, and said server decrypts said measurements at an application layer at said server prior to updating said resource with said measurements.

8. The method of claim 1, wherein generating said plurality of redacted representations comprises overriding redactions of said resource previously performed by a sensor.

9. The method of claim 1, further comprising providing said client with one of said plurality of redacted representations regardless of said client's claimed authorization level when said one of said plurality of redacted representations contains one or more of said plurality of data pieces that are tagged with an urgency level that is within a range of urgency levels tied to said client's responsiveness level.

10. The method of claim 1, wherein said generation of said plurality of redacted representations further comprises receiving a search string and excluding one or more of said plurality of data pieces that contain data matching said search string from said plurality of redacted representations.

11. A method for providing redacted representations of data, comprising:
receiving encrypted measurements from a sensor at a service layer of a server;
decrypting said measurements at an application layer at said server;
updating a resource stored within said application layer at said server with said measurements, wherein said resource and said measurements each comprise one or more data pieces tagged with one of a plurality of redaction levels;
generating a redacted representation of said resource within said application layer at said server for a particular authorization level, said particular authorization level being mapped to a maximum redaction level, by including in the redacted representation each data piece of said resource that is tagged with a redaction level less than or equal to the maximum redaction level for said particular authorization level;
notifying through said service layer one or more subscribing clients that have been assigned said particular authorization level that said redacted representation is available; and
providing said redacted representation to any of said one or more subscribing clients that submit a request to access said redacted representation.

12. The method of claim 11, further comprising verifying that said request to access said redacted representation originated at a subscribing client that is entitled to said particular authorization level prior to providing that subscribing client access to said redacted representation.

13. The method of claim 12, wherein said verifying comprises checking a claimed authorization level within said request against a stored authorization level in an application database for the client from which said request originated.

14. The method of claim 12, wherein said verifying comprises:
obtaining a token from the client from which said request originated, said token comprising said client's validated authorization level, wherein said client obtained said token from an authentication server after having its identity verified by an authentication server; and
determining said client's authorization level from said token to verify that said client is entitled to a claimed authorization level in said request.
